(19) United States
(12) Patent Application Publication
(10) Pub. No.: US 2010/0301074 A1
(43) Pub. Date: Dec. 2, 2010

(54) APPARATUS FOR DISPENSING FOOD ITEMS AFTER PRE-SELECTED TIME INTERVALS

(76) Inventor: Jeffrey Koesterich, Teaneck, NJ (US)

Correspondence Address: L.C. BEGIN & ASSOCIATES, PLLC, 510 HIGHLAND AVENUE, PMB 403, MILFORD, MI, 48381, US

(21) Appl. No.: 12/577,776

(22) Filed: Oct. 13, 2009

Related U.S. Application Data
(60) Provisional application No. 61/181,342, filed on May 27, 2009.

(51) Int. Cl. G04C 23/00; B67D 7/06; B67D 7/08

(52) U.S. Cl. 222/644; 222/25; 222/638; 222/153.14; 222/153.11

(57) ABSTRACT

One embodiment of an apparatus for dispensing food items at pre-selected time intervals is provided. The apparatus may include a dispensing member, a receiving member, a timer and a locking member. The dispensing member may store at least one food item therewithin. The dispensing member may dispense a predetermined quantity of the at least one food item. The receiving member may receive the predetermined quantity of the at least one food item dispensed from the dispensing member. The receiving member may be accessed in an open state thereof for retrieving the dispensed food item. Further, the timer may measure a pre-selected time interval. The timer may be activated based on one of a user input and accessing of the receiving member for dispensed predetermined quantity of the at least one food item. The locking member may be configured to lock one of the dispensing member and the receiving member.

### CROSS-REFERENCE TO RELATED APPLICATION

This application claims the benefit of U.S. Provisional Application No. 61/181,342 filed on May 27, 2009, the disclosure of which is incorporated by reference.

### FIELD OF THE DISCLOSURE

The present disclosure generally relates to food dispensers, and, more particularly, to an apparatus for dispensing food items after pre-selected time intervals.

### BACKGROUND OF THE DISCLOSURE

While indulging in various leisure activities at home such as watching a television program and the like, people tend to keep food items alongside. Generally, the food items may include snacks such as candies, wafers, nuts, and the like. At times, many individuals may become so engrossed in watching a television program, a movie, and the like, that they may fail to keep a check on an amount of food items being consumed by them, thereby resulting in over-eating. Especially, children may continue to eat until the food items are taken away from them or until the food items are finished.

Similarly, adult individuals may tend to indulge in over-eating when a bowl, having the food items such as snacks, remains lay open in front of them for longer durations. Such over consumption of the snacks may lead to intake of excessive amount of calories, thereby resulting in weight gain of the individuals. The amount of snacks consumed by an individual during a particular time interval needs to be checked.

### SUMMARY OF THE DISCLOSURE

One embodiment of an apparatus for dispensing food items after pre-selected time intervals may include a dispensing member. The dispensing member may store at least one food item therewithin. The dispensing member may dispense a predetermined quantity of the at least one food item. The apparatus may also include a receiving member. The receiving member may be carried by the dispensing member. The receiving member may receive the predetermined quantity of the at least one food item dispensed from the dispensing member. The receiving member may be accessed in an open state thereof for retrieving the dispensed food item.

Further, the apparatus may include a timer. The timer may measure a pre-selected time interval. The timer may be carried by the dispensing member and may be activated based on one of a user input and closing of the receiving member after retrieving the dispensed predetermined quantity of the at least one food item. The apparatus may also include a locking member. The locking member may be operatively coupled to the timer. The locking member may be configured to lock one of the dispensing member and the receiving member, which may deny access to the predetermined quantity of the at least one food item. The dispensing member may be locked based on one of the user input and the receiving member being locked upon assuming a closed state. Moreover, the locking member may be configured to unlock the one of the dispensing member and the receiving member upon elapse of the pre-selected time interval.

### BRIEF DESCRIPTION OF THE DRAWING

The advantages and features of the present disclosure will become better understood with reference to the following detailed description and claims taken in conjunction with the accompanying drawing, wherein like elements are identified with like symbols, and in which:

FIG. 1 is a perspective view of an embodiment of an apparatus for dispensing food items after pre-selected time intervals.

### DETAILED DESCRIPTION OF THE DISCLOSURE

The exemplary embodiments described herein provide detail for illustrative purposes and are subject to many variations in structure and design. It should be emphasized, however, that the present disclosure is not limited to a particular apparatus for dispensing food items after pre-selected time intervals, as shown and described. It is understood that various omissions and substitutions of equivalents are contemplated as circumstances may suggest or render expedient, but these are intended to cover the application or embodiment without departing from the spirit or scope of the claims of the present disclosure. In addition, it is to be understood that the phraseology and terminology used herein are for the purpose of description and should not be regarded as limiting.

The use of terms, “including,” or “comprising,” and variations thereof herein is meant to encompass the items listed thereafter and equivalents thereof as well as additional items. The terms “a” and “an” herein do not denote a limitation of quantity, but rather denote the presence of at least one of the referenced item. Further, the term, “top,” and the like, herein do not denote any order, elevation or importance, but rather are used to distinguish placement of one element over another.

The present disclosure provides an apparatus for dispensing food items, specifically after pre-selected time intervals. The apparatus may prevent individuals from over-dispensing as the food items may be accessed only after an elapse of the pre-selected time interval.

As disclosed herein the term “food item” may relate to a snack food. Examples of the snack food may include, but are not limited to candies, wafers, nuts, and the like. Further, the term “pre-selected time interval” may relate to a time interval chosen by a user before elapse of which the disclosed apparatus may deny the user an access to the food items stored in the apparatus. The duration of the time interval may vary as per the user's requirement and settings of the apparatus.

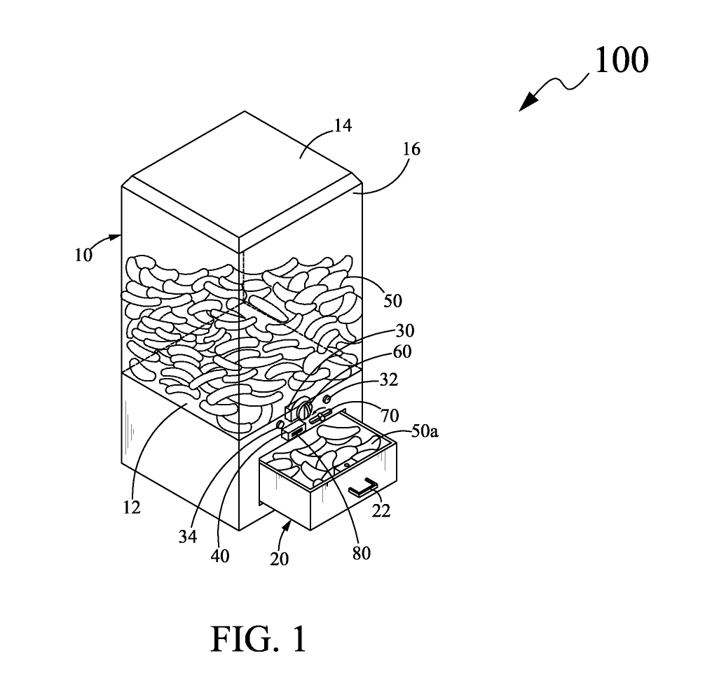

Referring to FIG. 1, a perspective view of an embodiment of an apparatus 100 for dispensing food items after pre-selected time intervals is illustrated. The apparatus 100 may include a dispensing member 10. The dispensing member 10 may store at least one food item such as a food item 50 therewithin. Further, the dispensing member 10 may be configured to dispense a predetermined quantity of the food item 50 on elapse of the pre-selected time interval. Specifically, the dispensing member 10 may include a dispensing mechanism (not shown) to facilitate dispensing of the predetermined quantity of the food item 50. The dispensing mechanism as appropriated herein may be similar to a gumball machine type mechanism conventionally known in the art, and accordingly is not explained in detail. In the present embodiment, the dispensing member 10 may be configured to assume a cuboidal shape (as shown in FIG. 1). However, the dispensing member 10 may assume any shape known in the art, such as a spherical shape and the like.

The dispensing member 10 may include a base member 12. Specifically, the base member 12 may be operatively coupled to the dispensing mechanism of the dispensing member 10. The base member 12 may include an opening (not shown) configured therethrough to allow dispensing of the predetermined quantity of the food item 50. Specifically, upon elapse of the pre-selected time interval, the dispensing mechanism may be activated; further, the dispensing mechanism may facilitate the base member 12 to dispense the predetermined quantity of the food item 50 through the opening.

The dispensing member 10 may also include a lid member 14. The lid member 14 may be configured to cover an open top portion 16 of the dispensing member 10. The lid member 14 may facilitate refilling the dispensing member 10 with the food item 50. Specifically, while refilling the dispensing member 10 with the food item 50, the lid member 14 may be removed from the open top portion 16 and the dispensing member 10 may be refilled with the food item 50.

The apparatus 100 may also include a receiving member 20. The receiving member 20 may be carried by the dispensing member 10 in a manner that the predetermined quantity of the food item 50 dispensed from the dispensing member 10 may be received or collected by the receiving member 20. Moreover, the receiving member 20 may allow the user to access the dispensed food items, such as the food item 50a. Specifically, the receiving member 20 may assume one of an open state and a closed state such that in the open state thereof (as illustrated in FIG. 1), the receiving member 20 may be accessed for retrieving the dispensed portion of the food item 50a therefrom.

In the present embodiment, the receiving member 20 may be a drawer (as shown in FIG. 1) that may be slidably carried by the dispensing member 10. Further, the receiving member 20 may include a handle member 22 configured thereon. The handle member 22 may be gripped and pulled out to open the receiving member 20 and pushed in to close the receiving member 20.

Further, the apparatus 100 may include a timer 30. The timer 30 may be configured to measure the pre-selected time interval. The value of the pre-selected time interval may be selected by a user. The timer 30 may be operatively coupled to the receiving member 20. The timer 30 may be activated to measure an elapse of time, specifically, the pre-selected time interval from the instant of closure of the receiving member 20. The timer 30 may be activated based on one of a user input and closing of the receiving member 20 after retrieving the dispensed portion of the food item 50a.

In one form of the present disclosure, the user input may be operating a rotary dial, such as a rotary dial 60, which may be operatively coupled to the timer 30. The rotary dial 60 may facilitate selection of the pre-selected time interval. Specifically, the rotary dial 60 may be rotated to select a value of the pre-selected time interval as desired by the user. In another form, the timer 30 may be activated upon closing of the receiving member 20 after retrieving the dispensed portion of the food item 50a from the receiving member 20. Specifically, the dispensed portion of the food item 50a may be retrieved and thereafter, the receiving member 20 may be closed such that the closing of the receiving member 20 may activate the timer 30. As mentioned herein, the pre-selected time interval may be a duration of time until the user may be restricted from accessing the predetermined quantity of the food item 50. Upon elapse of the pre-selected time interval, the user may be allowed access to the predetermined quantity of the food item 50.

In one form, the apparatus 100 may include at least one indicator operatively coupled to the timer 30 for providing an indication upon elapse of the pre-selected time interval. The indicator may indicate one of a visual indication and an audio indication for manifesting the elapse of the pre-selected time interval. The visual indication may be provided by a pair of light bulbs such as a green light bulb 32 and a red light bulb 34. The glowing or blinking of the green light bulb 32 may indicate that the pre-selected time interval of the timer 30 has elapsed, and the predetermined quantity of the food item 50 may be retrieved by the user. Moreover, the glowing or blinking of the red light bulb 34 may indicate that the pre-selected time interval of the timer 30 has not yet elapsed, and the predetermined quantity of the food item 50 may be inaccessible to the user. Further, the visual indication may be provided by any other means known in the art. Moreover, an audio indication may be incorporated in the apparatus 100. The audio indication may provide a beeping sound or any other alarm known in the art.

The apparatus 100 may also include a locking member 40. The locking member 40 may be operatively coupled to the timer 30. As disclosed herein, the locking member 40 may be configured to lock one of the dispensing member 10 and the receiving member 20. Specifically, the locking member 40 may lock the base member 12 of the dispensing member 10 such that the predetermined quantity of the food item 50 may be prevented from being dispensed therefrom, which may restrict an access to the predetermined quantity of the food item 50. In the present embodiment, the locking member 40 may be an electromagnetic lock. The electromagnetic lock may include a pin member (not shown) capable of engaging the receiving member 20 with the base member 12. The electromagnetic lock as disclosed herein may be similar to any electromagnetic lock known in the art and accordingly is not described in detail herein. Alternatively, the locking member 40 may be any other type of lock known in the art such as a power lock, and the like. Alternatively and additionally, the locking member 40 may be operated by at least one battery such as a battery 80.

In another embodiment, the apparatus 100 may include a knob member 70. The knob member 70 may be operatively coupled to the locking member 40. The knob member 70 may be rotated in a direction of the arrow (as shown in FIG. 1) to dispense the predetermined quantity of the food item 50 in the receiving member 20, when the pre-selected time interval elapses. Further, the knob member 70 may include a retracting member (not shown) for facilitating the knob member 70 to assume an initial position upon release of the knob member 70.

In order to dispense the predetermined quantity of the food item 50, the knob member 70 may be rotated in the direction of the arrow. The rotation of the knob member 70 may unlock the locking member 40. Thereafter, the dispensing mechanism may enable the base member 12 to dispense the predetermined quantity of the food item 50, upon elapse of the pre-selected time interval.

When the predetermined quantity of the food item 50 may be dispensed from the dispensing member 10, the retracting member may rotate the knob member 70 back to the initial position. The knob member 70 may thus facilitate in locking the dispensing member 10, until the pre-selected time interval may be elapsed, thereby restricting access to the food item 50.

For using the apparatus 100 to dispense food items such as the food item 50 after a lapse of a pre-selected time-interval, the user may adjust the timer 30 by means of the rotary dial 60, to a pre-selected time interval of his/her choice. Upon elapse of the pre-selected time interval, the indicator may provide an indication, such as a visual indication by turning on the green light bulb 32. The receiving member 20 may remain in an unlocked position until the receiving member 20 may be opened to access the predetermined quantity of the food item 50 dispensed from the dispensing member 10. Moreover, upon elapse of the pre-selected time interval, the dispensing member 10 may dispense the predetermined quantity of the food item 50 into the receiving member 20. The dispensed portion of the food item 50a may be accessed by the user from the receiving member 20. Specifically, the user may open the receiving member 20 for accessing the dispensed portion of the food item 50a, and thereafter may close the receiving member 20. Upon closing the receiving member 20, the locking member 40 may lock the receiving member 20, thereby restricting access to the food item to the user.

Upon closing the receiving member 20, the timer 30 may be activated automatically for determining elapse of the pre-selected time interval. Additionally, upon closing the receiving member 20, the green light bulb 32 may turn off while the red light bulb 34 may turn on for indicating that the access to the food item 50 stored in apparatus 100 is restricted.

In an alternate mode of operation, the closing of the receiving member 20 may activate the dispensing member 10 to dispense the predetermined quantity of the food item 50 into the receiving member 20. The receiving member 20 may be refilled with the predetermined quantity of the food item 50 that may be accessed by the user upon the elapse of pre-selected time interval.

The disclosed apparatus such as the apparatus 100 for dispensing food items after pre-selected time intervals may be fabricated in a variety of sizes. Further, any size of the apparatus may be produced in any shape known in the art based on user's preferences. Moreover, the apparatus may be produced from different materials such as a metal, a plastic material, and a combination thereof. Additionally, the exact dimensions, colors, and materials for the construction and operation of the apparatus may vary upon manufacturing.

The apparatus such as the apparatus 100 for dispensing food items at pre-selected time intervals may be advantageous for avoiding over-eating by individuals. Specifically, the apparatus may assist individuals in eating only a predetermined quantity of a food item, and that too after a pre-selected time interval.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present disclosure.

What is claimed is:

1. An apparatus for dispensing food items after pre-selected time intervals, the apparatus comprising:
a dispensing member capable of storing at least one food item therewithin, the dispensing member dispensing a predetermined quantity of the at least one food item;
a receiving member carried by the dispensing member, the receiving member capable of receiving the predetermined quantity of the at least one food item dispensed from the dispensing member, the receiving member capable of being accessed in an open state thereof for retrieving the dispensed food item;
a timer configured with the dispensing member, the timer capable of measuring a pre-selected time interval, the timer being activated based on one of a user input and closing of the receiving member after retrieving the dispensed predetermined quantity of the at least one food item; and
a locking member operatively coupled to the timer, wherein the locking member configured to lock one of the dispensing member and the receiving member, thereby restricting access to the predetermined quantity of the at least one food item, the dispensing member being locked following a user input; the receiving member being locked upon assuming a closed state, and being unlocked upon the elapse of the pre-selected time interval.

2. The apparatus of claim 1, wherein the dispensing member is configured to dispense the predetermined quantity of the food item following a determination of one of elapse of the pre-selected time interval measured by the timer and locking of the receiving member.

3. The apparatus of claim 1 further comprising a rotary dial operatively coupled to the timer, the rotary dial facilitating selection of the pre-selected time interval.

4. The apparatus of claim 1 further comprising at least one indicator operatively coupled to the timer, the at least one indicator capable of providing an indication upon elapse of the pre-selected time interval.

5. The apparatus of claim 4, wherein the indication is one of an audio indication and a visual indication.

6. The apparatus of claim 1, wherein the locking member is an electromagnetic lock.

7. The apparatus of claim 1, wherein the locking member is operated by at least one battery.

8. The apparatus of claim 1 further comprising a knob member operatively coupled to the locking member, wherein operations of the knob member facilitate in locking and unlocking of the dispensing mechanism.
